(19) United States
(12) Patent Application Publication
(10) Pub. No.: US 2026/0307024 A1
(43) Pub. Date: Oct. 8, 2026

(54) CONTINUOUSLY FILLABLE MIXER AND METHOD FOR CONTINUOUS PROCESSING OF INGREDIENTS

(71) Applicant: HS-TUMBLER GMBH, Quakenbrück (DE)

(72) Inventor: Bernhard Hukelmann, Quakenbrück (DE)

(21) Appl. No.: 19/108,311

(22) PCT Filed: Aug. 31, 2023
(86) PCT No.: PCT/EP2023/073891

§ 371 Date: Mar. 3, 2025

(30) Foreign Application Priority Data
Sep. 1, 2022 (DE) 10 2022 209 114.0

(51) Int. Cl. B01F 31/00; B01F 101/06

(52) U.S. Cl. CPC B01F 31/57; B01F 31/70; B01F 2101/06

(57) ABSTRACT

The invention relates to a mixer which has a container with an inlet opening and an outlet opening located opposite along its longitudinal axis, the container having a cross-section tapering along its longitudinal axis and being driven by a drive for reciprocating movement along a trajectory curve approximately perpendicular to its longitudinal axis.

The present invention relates to a mixer which is to be filled continuously and is set up so that the residence time within the mixer can be adjusted without an inlet or outlet valve on the mixer, and to a process for continuous mixing.

The mixer, which is particularly suitable for use as a mixer for mixing a fluid, liquid or gaseous, into a solid and/or into a liquid, e.g. for mixing a gas into or discharging a gas from a liquid, for mixing liquid into a solid, which is optionally present in combination with another liquid, or e.g. as a tumbler, also known as a massager, for the introduction of solid or liquid additives into solid foods, e.g. raw meat, enables continuous mixing of ingredients that are fed into the mixer and continuous discharge of the mixture after the contents have passed through the mixer. For example, the mixer is suitable for mixing a gas, e.g. air, into a liquid which is, for example, a nutrient medium for cultivating biological cells. Furthermore, the mixer can be used as a device for degassing liquids or curable masses, e.g. curable plastics mixtures or hardenable cement or concrete mixtures.

### STATE OF THE ART

EP 3 099 178 B1 for the treatment of raw meat describes an arrangement of work surfaces driven for reciprocating movement, one of which work surfaces can be movable for filling or emptying.

### OBJECT OF THE INVENTION

The object of the invention is to provide an alternative mixer and a method which can be carried out therewith for mixing of contents, optionally for degassing liquids, e.g. curable masses, wherein contents can be continuously supplied and discharged after passing through the mixer, preferably with no valves or flaps controlling openings of the mixer. Preferably, the mixer should have an inlet opening to which an inlet line is connected and an outlet opening to which an outlet line is connected, in each case without a valve or flap between one of the openings and a line.

### DESCRIPTION OF THE INVENTION

The invention achieves the object by the features of the claims and in particular by means of a mixer which has or consists of
a container with an inlet opening and an outlet opening located opposite along its longitudinal axis, wherein the container can have a constant cross-section along its longitudinal axis, e.g. can be cylindrical, or preferably the container extends with a tapering cross-section from a terminal larger cross-section to a terminal smaller cross-section and the inlet opening is arranged in the region of the terminal larger cross-section, e.g. is formed by the terminal larger cross-section, and the outlet opening is arranged in the region of the terminal smaller cross-section or is formed by the latter, the container being pivoted by a drive for reciprocating movement along a trajectory curve approximately perpendicular to or at an angle to its longitudinal axis about a central position of its longitudinal axis, which extends between the terminal cross-sections, wherein the trajectory curve optionally extends in the plane of the cross-section of the container or the trajectory curve extends along a curved plane when the container is pivoted, wherein the container is preferably and/or not driven to rotation, in particular not driven for complete rotation about e.g. its longitudinal axis, e.g. rotatable by a maximum of 90°, a maximum of 45°, a maximum of 30°, a maximum of 20° or a maximum of 10°, wherein the longitudinal axis extends e.g. between the inlet opening and the outlet opening,
preferably with a movable first inlet line connected to the inlet opening,
preferably without a valve between the inlet line and the inlet opening and
preferably with a movable outlet line connected to the outlet opening,
further preferably without a valve between the outlet opening and the outlet line,
wherein optionally the drive is formed by a first partial drive and a second partial drive spaced apart therefrom along the longitudinal axis of the container, of which the first partial drive drives the container along a first trajectory curve and the second partial drive drives the container along a second trajectory curve different from the first trajectory curve.

Preferably, the first partial drive is attached closer to the inlet opening than the second partial drive and the first trajectory curve has a longer path and/or a higher frequency of the reciprocating movement than the second trajectory curve. Thus, the first trajectory curve can have a longer path, also referred to as path length, than the second trajectory curve, with the same or higher frequency of the reciprocating movement along the trajectory curve than the second trajectory curve, or the first trajectory curve can have the same or a shorter path, also referred to as path length, than the second trajectory curve, with a higher frequency of the reciprocating movement along the trajectory curve than the second trajectory curve. In general, the first trajectory curve is set up to accelerate the container in the region of the arrangement of the first partial drive more strongly relative to the contents in the container than the second trajectory curve is set up to accelerate the container in the region of the arrangement of the second partial drive relative to the contents in the container.

For a drive which has a first partial drive and a second partial drive, the first trajectory curve and the second trajectory curve can each be generated by a reciprocating movement along two longitudinal axes arranged at an angle to each other and perpendicular to the longitudinal axis of the container, which are optionally each arranged in a common plane arranged perpendicular to the longitudinal axis or in planes spaced apart along the longitudinal axis. The movements of the container along the first and second trajectory curves are superimposed, e.g. to form a reciprocating movement about the longitudinal axis of the container, and result in the contents of the container being conveyed in the direction of the terminal cross-section, which lies close to the first partial drive.

Optionally, the container has a second inlet line for a fluid, liquid or gaseous, connected in the region of the inlet opening. The second inlet line can be connected in the region of the inlet opening, in particular of the cross-sectional opening. Further optionally, the container has an inner wall that is only permeable to fluids, in particular only permeable to gases, which is spaced from the container wall, with the second inlet line opening in the interstitial space between the container wall and the inner wall. Such an inner wall is impermeable to solids, optionally to liquids. The inner wall can be a porous ceramic wall or porous plastic wall, a semi-permeable plastic membrane or a sheet metal with small borings, e.g. produced by laser irradiation, which have a cross-section of 50 to 500 μm or up to 200 μm, for example.

Preferably, the larger terminal cross-section of the container forms the outlet opening; alternatively, the smaller cross-section of the container forms the outlet opening.

The tapered cross-section of the container can be at least quadrangular, pentagonal or at least hexagonal, preferably round. The cross-section can be constant along the longitudinal axis or it can, for example, taper from the terminal larger cross-section to the opposite terminal smaller cross-section, so that, for example, the terminal smaller cross-section is 90% to 10%, for example 80% to 20% or up to 30%, preferably up to 40% or up to 50% of the size of the terminal larger cross-section. Optionally, the shape of the cross-section of the container may change along its longitudinal axis, e.g. from a section having a hexagonal cross-section to an adjacent cylindrical section, and further optionally to a section adjacent thereto having a triangular cross-section. Generally, the inner surface of the container may have a structure with protrusions and/or recesses extending, for example, by 0.2 to 10 mm or up to 5 mm or up to 2 mm from the container wall.

The mixer is adapted to hold contents for a dwell time by being set up for a reciprocating movement by means of a drive along the trajectory curve approximately perpendicular to its longitudinal axis or pivoted at an angle about a central position of its longitudinal axis extending between the terminal cross-sections, as during the reciprocating movement the contents by the container wall are moved towards the inlet opening. This is because the cross-section tapering from the area of the inlet opening is formed by a container wall which is inclined towards the inlet opening at an angle of less than 180°, so that contents are also accelerated towards the inlet opening by impacting during the reciprocating movement. Furthermore, even in the case of a container with a cross-section that is constant or not tapered along the entire longitudinal axis, which is spanned by the container wall or an inner wall mounted therein at a spacing, the conveying of contents along the longitudinal axis can additionally or alternatively be driven by the movement of the container along a trajectory curve, in which the container is pivoted about a central position of its longitudinal axis. The container can generally be pivoted by an angle of e.g. 2 to 90°, e.g. 5 to 45° or up to 30° or up to 10° about a central position of its longitudinal axis during the reciprocating movement along a trajectory curve, in particular with two partial drives arranged with a spacing along the longitudinal axis or with a cardanic bearing of the container with a drive spaced apart therefrom. The cardanic bearing can be formed by a bearing that is a gimbal bearing or a ball joint. Preferably, the cardanic bearing holds the container stationary. Optionally, the cardanic bearing holds the container so that it is rotatable by a maximum of 30°, preferably a maximum of 20° or a maximum of 10° about its longitudinal axis or is held non-rotatably in the cardanic bearing.

Therefore, the mixer is set up to control the dwell time by the reciprocating movement along the trajectory curve, in particular its frequency and path length, as well as by the mass flow of contents fed through the inlet opening. Preferably, a controlled dosing device, e.g. at least one pump, dosing screw and/or dosing valve, is connected to the first inlet line in order to continuously dose contents into the first inlet line. An optional second inlet line, which is connected, for example, to a source of compressed gas, which can be a compressed gas cylinder or a compressor, is connected, for example, to the container in the area of the inlet opening. If an inner wall is arranged in the container, a second inlet line, which opens into the interstitial space between the container wall and the inner wall, can be connected in the region between the inlet opening and the outlet opening.

A vacuum source, e.g. the suction opening of a vacuum pump, can optionally be connected to the second inlet line, which opens between the container wall and the gas-permeable inner wall, so that the mixer can be used as a device for degassing masses. When the container is moved reciprocating along the trajectory curve, the contents contained in it are moved along the inner wall and any gas contained is released from the contents and can be sucked through the inner wall into the second inlet line, which thereby is used as a suction line.

The mixer has the advantage that no elements are arranged within the container that can move relative to one another and that no valve is arranged at the inlet opening and preferably no valve is arranged at the outlet opening or at the outlet line. A further advantage is that the mixer, also when used for degassing masses, permits a continuous throughput of contents which are fed in through an inlet line and discharged through an outlet line.

Optionally, the outlet line has a larger cross-section than the outlet opening, so that the outlet line offers less resistance to the mixture exiting than the outlet opening. Further optionally, the outlet line has a larger cross-section than the inlet opening, so that the outlet line offers less resistance to the escaping mixture than the inlet opening.

The inlet line and the outlet line can each be formed independently of one another by an elastic hose. An elastic hose has the advantage of compensating for the reciprocating movement of the container relative to the end of the hose opposite the container or of following the movement, especially if the hose is fixed at a distance from the container, e.g. on a frame in which the container is driven to a reciprocating movement.

Preferably, the dosing device is set to dose the contents continuously with a mass flow which results in an average dwell time of the contents within the container during the reciprocating movement along the trajectory curve of 30 s to 10 min, preferably up to 5 min or up to 4 min or up to 3 min or up to 2 min or up to 1 min.

In general, the mixer is set up to drive the container along a trajectory curve which is formed by superimposing the reciprocating movements of at least two superimposed linear axes which are at an angle to one another, the reciprocating movement along the linear axes taking place at different frequencies and/or with a phase offset. The linear axes along which the superimposed reciprocating movements take place at different frequencies and/or with phase offset form the trajectory curve along which the reciprocating movement of the container takes place, for which the mixer is set up. In embodiments in which the drive is formed by a first partial drive and a second partial drive spaced apart therefrom along the longitudinal axis of the container, the container is driven along a first trajectory curve in the region of the first partial drive and along a second trajectory curve in the region of the second partial drive, so that the movement of the container results from the superposition of the movements along the first and second trajectory curves. In general, each of the first and second trajectory curves can be one of the trajectory curves as described.

By moving the container along the trajectory curve, the mixer is set up to accelerate solid and/or liquid contents relative to the container, so that contents contained in the container by the acceleration are accelerated against the container wall in the direction of the larger cross-section or in the direction of the terminal cross-section, which is arranged close to the first partial drive, and are brought into contact with the container wall, optionally with an inner wall arranged therein, and, for example, are mixed with one another.

Since the trajectory curve can be adjustable or predetermined by the different frequencies and/or the phase offset of the superimposed movements along the linear axes, the mixer is set up for reciprocating movement of the container along the trajectory curve and for accelerating the contents in the direction of the larger cross-section, resp. in the direction of the terminal cross-section, which is arranged close to the first partial drive, so that the dwell time of the contents in the container can be adjusted by this and by the mass flow which is dosed through the inlet opening, in particular controlled by the dosing device. In the embodiment in which the container is driven along a first trajectory curve by a first partial drive and along a second trajectory curve by a second partial drive, the container can have a constant cross-section along its longitudinal axis, e.g. be cylindrical, since the difference in path length and/or in frequency between the reciprocating movements of the first and second trajectory curves drives or conveys the contents along the container.

Generally preferably, the container is not rotationally driven and further preferably not or not completely rotatable, e.g. guided rotatably by a maximum of 30° or by a maximum of 20° or 10° about its longitudinal axis. Generally preferred, the container is driven exclusively for a reciprocating movement along a trajectory curve or along a first trajectory curve and a second trajectory curve. For example, the container is not fully rotatable in that it is pivotably articulated to a drive and/or is mounted pivotably in a cardanic bearing so that it cannot rotate. Because the container is driven for movement, in particular for reciprocating movement, along a trajectory curve and is not rotationally driven and/or is not fully rotatable, e.g. is only pivoted by the drive for movement along the trajectory curve, the movement of the container causes intensive shearing of the container contents, resp. of the ingredients, along the container wall. Preferably, the container is offset and/or pivoted or tilted during movement along a trajectory curve and is not driven for complete rotation or preferably for rotation by a maximum of 30° or a maximum of 10° about its longitudinal axis.

Optionally, the mixer is set up to move the container with an adjustable or a predetermined acceleration and speed along the trajectory curve, which may be a first trajectory curve driven by a first partial drive and a second trajectory curve spaced therefrom along the longitudinal axis of the container and driven by a second partial drive. In that the mixer is set up for an adjustable or predetermined trajectory curve and/or an adjustable or predetermined acceleration and/or an adjustable or predetermined speed along the trajectory curve of the reciprocating movement of the container, the contents are driven with an adjustable or a predetermined acceleration and/or speed relative along the container wall or along an inner wall arranged therein with a spacing, and the mixer permits a predetermined or continuous adaptation of the process to contents to be treated, e.g. contents to be mixed or masses to be degassed.

In general, a trajectory curve can be formed by at least two superimposed individual oscillations, preferably each trajectory curve is equal to the trajectory curve that can be generated by superimposing reciprocating movements along at least two linear axes of movement at different frequencies and/or by phase offset. A reciprocating movement along a trajectory curve that is equal to the reciprocating movement along linear axes of movement that are superimposed on one another have different frequencies and/or have a phase offset to one another. In general, a trajectory curve is therefore not a circular path.

The difference in frequencies can, for example, be at least 0.01 Hz and/or 0.01% to 900%. The phase offset of the reciprocating movements along the linear axes can be, for example, from 0.01° to 180°, preferably 1 to 179° of 360°, which corresponds to a complete reciprocating movement. In this case, 0.01 to 180° of a complete reciprocating movement of 360° is equal to 0.0028% to 50% of a complete reciprocating movement, 1 to 179° of 360° is equal to 0.28% to 49.7% of a complete reciprocating movement.

Therein, the linear axes of movement are, for example, perpendicular or at a different angle, e.g. 5° to 85° to each other, in particular in the plane of the cross-section of the container and/or perpendicular to a central axis of the container. Optionally, the trajectory curve contains at least one rectilinear section, the end of which is, for example, an apex of the trajectory curve, at which the contents or mass are accelerated away from the container wall or against the container wall.

In order to set different frequencies and/or a phase offset of the superimposed reciprocating movements along at least two linear movement axes, these reciprocating movements can be coupled together by a transmission or a link guide and driven by a motor. A transmission driven by a motor, which adjusts the reciprocating movement along the trajectory curve, can have a fixed transmission ratio between the superimposed movements along each axis, or an adjustable transmission ratio, e.g. a continuously or incrementally shiftable gearbox. Optionally, the transmission can be slip-loaded, e.g. have a belt drive or be a friction gearbox.

The output rotational speed of the transmission, which drives the reciprocating movement of the container along a trajectory curve, is preferably at least 1 Hz, more preferably at least 5 Hz, e.g. up to 50 Hz, up to 40 Hz, up to 30 Hz, up to 20 Hz or up to 10 Hz. The output rotational speed of the transmission is equal to the frequency of the reciprocating movement.

Alternatively, the reciprocating movement along each of the linear axes of movement may be driven by a separate motor, wherein for the purposes of the invention, the lower output rotational speed is the frequency of the reciprocating movement and forms the frequency of the sequence of trajectory segments. In each embodiment, the revolutions of each drive motor may be controlled, fixed or variable over the duration of the process.

Optionally, the mixer is set up to change the trajectory curve of the reciprocating movement and/or the acceleration and/or speed of the reciprocating movement during the process, e.g. to adjust the reciprocating movement along an initial trajectory curve and with a first acceleration and speed in a first phase and to adjust the reciprocating movement along a changed trajectory curve and/or changed acceleration and/or speed in a subsequent second phase.

Further optionally the reciprocating movement is a linear reciprocating movement in a first phase and a reciprocating movement along merging trajectory curves in a second phase. Each trajectory curve can, for example, be determined by a transmission that drives the movement of the container.

The mixer allows a predetermined or dynamically variable and directed acceleration of the contents relative to the container by adjusting the trajectory curve and acceleration of the reciprocating movement of the container. Solids and liquid contents that are present on the container wall or on an inner wall are accelerated against the container wall or inner wall, accelerated by this in the direction of the larger cross-section and e.g. are mixed.

In an embodiment, in which the container can be driven in a controlled manner in a first phase to a linear reciprocating movement, the mixer is set up to move contents in perpendicular against the container wall with a controllable acceleration maximum, which is significantly greater than the acceleration due to gravity and is therefore essentially independent of the acceleration due to gravity, e.g. with an acceleration maximum of at least 15m/s² , preferably 25m/s² , preferably at least 50 m/s² or at least 100 m/s² or at least 200 m/s² or at least 350 m/s², e.g. up to 500 m/s² in each case.

In general, the mixer can be set up to accelerate the container with a maximum acceleration of at least 20 m/s² or at least 200 m/s² , e.g. at least 300 m/s² , preferably up to 1000 m/s² along the trajectory curve, e.g. at an apex of the trajectory curve.

The container is preferably driven to a reciprocating movement with a maximum acceleration of at least 0.5 m/s² or at least 1 m/s² or at least 2 m/s², at least 3.5 m/s², preferably at least 60 m/s², more preferably at least 100 m/s², at least 150 m/s², at least 160 m/s², at least 200 m/s², e.g. in each case up to 300 m/s² or 450 m/s² , up to 260 m/s² or up to 250 m/s² along each of two axes. Generally preferably, the container is driven in combination with the acceleration maximum to an average speed of at least 0.5 m/s, preferably at least 2 m/s, more preferably at least 3.5 m/s, e.g. up to 10 m/s or up to 20 m/s or up to 6 m/s, e.g. 3 to 4 m/s, in each case along one of the axes, preferably along each axis. The path of the movement along at least one axis, preferably along each axis, is e.g. 0.1 cm to 50 cm, e.g. 5 to 30 cm or up to 15 cm.

The container can, for example, be driven to perform a reciprocating movement which extends along each axis over a distance of at least 1 mm or at least 2.5 mm, at least 1 cm, more preferably at least 2 cm or at least 5 cm, at least 10 cm or at least 15 cm, e.g. up to 100 cm, up to 50 cm, up to 30 cm or up to 20 cm in each case. Further preferably, the reciprocating movement of the container is harmonious. The reciprocating movement of the container can be linear in a first phase. Generally, the trajectory curve is non-linear and can be, for example, sinusoidal, triangular or arcuate, optionally running along a so-called Lissajous figure or a hypocycloid, which preferably lies in a plane, resp. is two-dimensional, optionally three-dimensional. Preferably, the reciprocating movement is linear in a first phase and in a second phase along at least two merging, non-linear trajectory segments, each containing at least one apex, forming a trajectory curve. In general, a non-linear trajectory curve, e.g. a movement along a trajectory curve whose trajectory segments each have at least one apex, promotes a high acceleration of the contents against the container wall.

Preferably, the reciprocating movement comprises the reciprocating movement along a trajectory curve which comprises at least two, preferably at least three, more preferably at least four trajectory segments, each of which has at least one apex. Each of the movement axes along which the movements are superimposed to form a trajectory curve can generally be linear or arcuate, so that the non-linear movement of the container along a sequence of trajectory segments is generated from the superimposition of the movements along two movement axes. The apices and intermediate sections of a trajectory segment are determined by the frequency difference and/or by the phase position of the superimposed reciprocating movements along at least two axes. In general, the mixer can be set up to change the frequency difference and/or the phase position during the reciprocating movement.

In general, the container wall is preferably the circumferentially closed wall of the container, which extends around a longitudinal axis and between respective terminal opposite cross-sections or lids attached thereto. The container has an optionally circular cross-section that extends around a longitudinal axis and is spanned by the container wall. Generally preferably, the terminal cross-sections of the container are each covered by a lid, the larger of which has an inlet opening and the smaller of which has an outlet opening.

It is generally preferred that at least one trajectory segment has an apex at which the direction of the trajectory segment changes by at least 90°, more preferably by at least 120°, even more preferably by at least 180° or at least 210°, e.g. within a maximum of 24.5%, a maximum of 24%, a maximum of 23%, a maximum of 22%, a maximum of 21%, a maximum of 20%, a maximum of 15% or a maximum of 10%, more preferably a maximum of 5% or a maximum of 3%, a maximum of 2% or a maximum of 1% of the length of a trajectory segment. This is because an apex of the trajectory segment leads to a strong relative acceleration of the contents against the container wall.

Optionally, the container, in particular if it contains an inner wall with openings, may contain solids that are freely movable, e.g. mineral solids, e.g. corundum. In the process, such freely movable solids cause deposits to be removed from the inner wall or container wall during the reciprocating movement, particularly in processes for filtration, e.g. in treatment of water or of waste water.

The mixer can be used as a device for processing recyclable material, in particular for separating liquids, which are drawn off through openings in the inner wall, from solids, which emerge through the outlet opening.

The invention will now be described in more detail by way of example with reference to the figures, which schematically show in

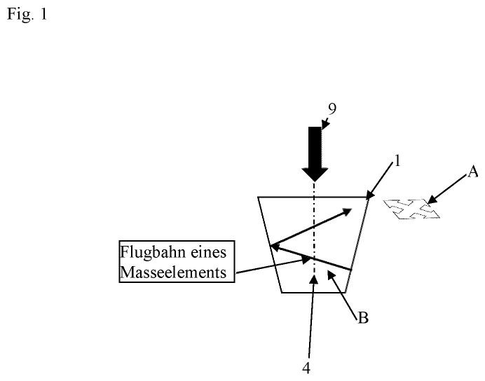

FIG. 1 an embodiment,

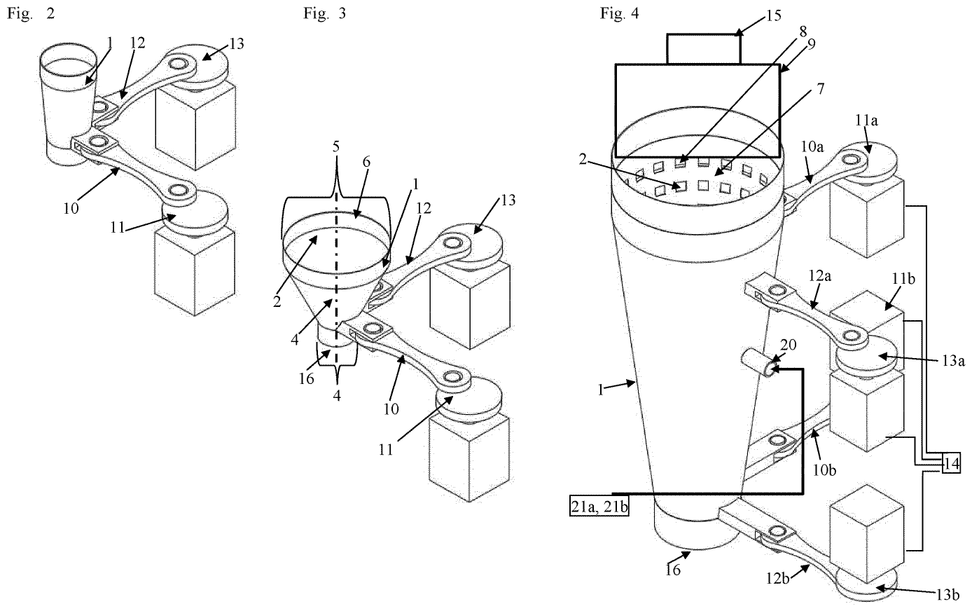

FIG. 2 a further embodiment,

FIG. 3 a further embodiment

FIG. 4 a still further embodiment,

FIG. 5 an embodiment with a cylindrical container,

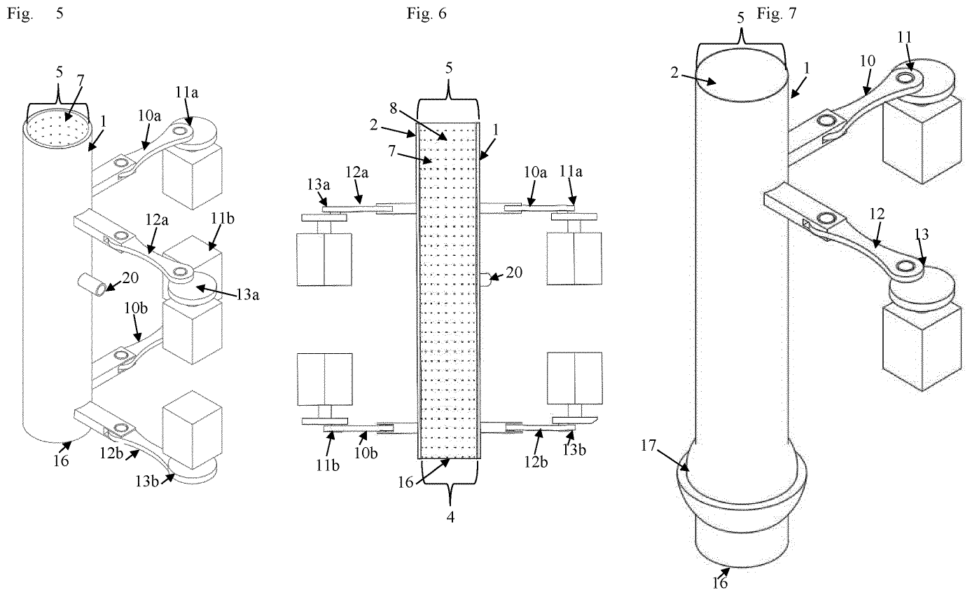

FIG. 6 an embodiment with longitudinal section through a cylindrical container,

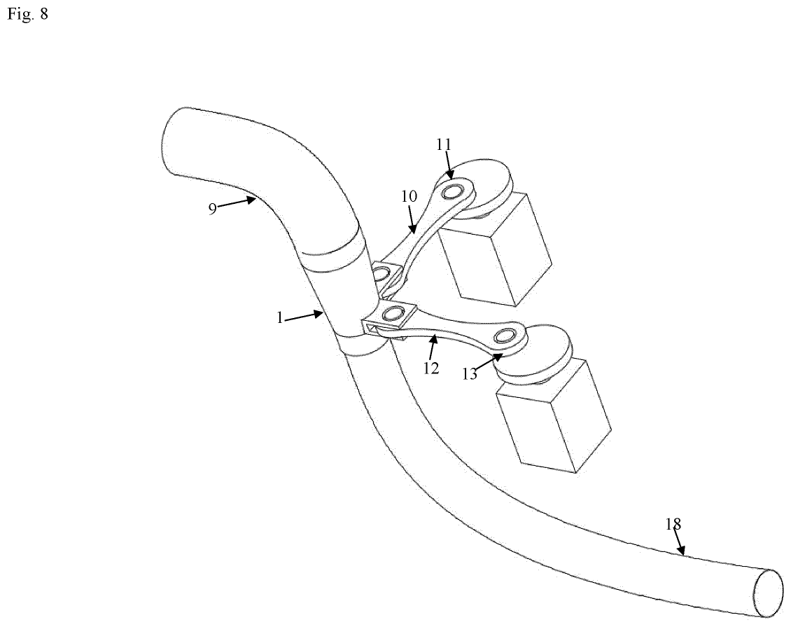

FIG. 7 a mixer with guidance of the container in a cardan bearing and with a drive, and

FIG. 8 an embodiment with a permanently connected inlet line and a permanently connected outlet line.

In the figures, identical reference signs indicate elements with the same function.

FIG. 1 shows the reciprocating movement A of the container 1 along a trajectory curve in a plane that is arranged in parallel to the cross-section of the container 1. Due to the loading of the container wall 2 relative to the contents B, the reciprocating movement A results in a proportional acceleration of the contents B also in the direction from the smaller terminal cross-section 3 to the larger cross-section 5 opposite along the longitudinal axis 4. The larger terminal cross-section 5 forms an inlet opening 6, resp. an inlet opening 6 is arranged adjacent to or in the region of the larger terminal cross-section 5. In the embodiment shown here, the container 1 tapers from a larger cross-section 4 to the smaller cross-section 3. An inlet line 9, which feeds contents to be mixed from a dosing device, is connected to the inlet opening 6.

FIG. 2 shows a drive which is driven to a reciprocating movement along a trajectory curve by means of a first lever 10, which is driven by a first eccentric drive 11 for reciprocating movement, and by means of a second lever 12, which is arranged approximately perpendicular to the first lever 10 and by means of a second eccentric drive 13 for reciprocating movement, the first and second levers 10, 12 being arranged perpendicular to the longitudinal axis 4 of the container 1.

FIG. 3 shows a container 1 that tapers more from the larger cross-section 5 to the smaller cross-section 3 than the container 1 of FIG. 2. The smaller terminal cross-section 3 forms the outlet opening 15.

FIG. 4 shows an embodiment in which the container 1 can have a constant cross-section over its longitudinal axis 4, e.g. can be cylindrical, or, as shown here, can have a cross-section tapering from a terminal larger cross-section 5 to the smaller cross-section 3. The drive has a first partial drive with a first lever 10a driven by a first eccentric drive 11a and in the same plane perpendicular to the longitudinal axis 4 of the container 1 a second lever 12a driven by a second eccentric drive 13a. At a spacing along the longitudinal axis 4, a second partial drive is articulated to the container, which has a further first lever 10b driven by a further first eccentric drive 11b and a further second lever 12b driven by a further second eccentric drive 13b

Generally, the first levers 10a, 10b are arranged at a spacing along the longitudinal axis 4, and the second levers 12a, 12b are arranged at the same or a different spacing along the longitudinal axis 4. The levers 10a, 10b of the first partial drive and the levers 12a, 12b of the second partial drive can generally be arranged in parallel to each other or offset along the circumference of the container 1.

The control unit 14 is set up to drive the first partial drive 10a, 11a, 12a, 13a and the second partial drive 10b, 11b, 12b, 13b each with a different frequency. Alternatively or additionally, the first partial drive 10a, 11a, 12a, 13a and second partial drive 10b, 11b, 12b, 13b can be set up to drive the container 1 along a trajectory curve of different path length, e.g. by first levers 10a, 10b of different lengths and/or second levers 12a, 12b of different lengths and/or by first eccentric drives 11a, 11b pivoting out at different distances and/or second eccentric drives 13a, 13b pivoting out at different distances.

FIG. 4 in the container 1 shows an inner wall 7, which has openings 8 through which the container wall 2 is visible, and a second inlet line 20, which opens in the interstitial space between the container wall 2 of the container 1 and the inner wall 7. A source 21a for pressurized gas or a vacuum source 21b, e.g. a suction pump, can be connected to the second inlet line 20.

FIG. 5 shows a mixer container 1 which has a constant cylindrical cross-section over its entire longitudinal axis and which is driven by a first partial drive with a first lever 10a, a first eccentric drive 11a, a second lever 12a and a second eccentric drive 13a and a second partial drive at a spacing from it with a first lever 10b, a first eccentric drive 11b, a second lever 12b and a second eccentric drive 13b for reciprocating movement along a trajectory curve. The container 1 has an inner wall 7 with openings 8 and a second inlet line 9 connected to the interstitial space between the container wall 2 and the inner wall 7.

FIG. 6 shows the cylindrical container 1 of FIG. 5 in longitudinal section with the inner wall 7, which has openings 8, shown here in the form of dots.

FIG. 7 shows an embodiment in which the container 1 is cardanically mounted in a bearing 17, which is for example a cardan bearing or ball joint, and at a spacing along its longitudinal axis has a drive with a first lever 10, a first eccentric drive 11, a second lever 12 and a second eccentric drive 13, which can pivot the container along a trajectory curve at an angle about a central position.

FIG. 8 shows a container 1 whose opposing cross-sectional openings 3, 5 are connected between a inlet line 9 and an outlet line 18 and the container 1 is connected to a drive having a first lever 10, a first eccentric drive 11, as well as a second lever 12 and a second eccentric drive 13 for reciprocating movement along a trajectory curve. The inlet line 9 and the outlet line 18 can each be formed by an elastic hose line.

### REFERENCE SIGN

A reciprocating movement
B contents
1 container
2 container wall
3 terminal (smaller) cross-section
4 longitudinal axis
5 terminal (larger) cross-section
6 inlet opening
7 inner wall
8 opening
9 inlet line
10, 10a, 10b first lever
11, 11a, 11b first eccentric drive
12, 12a, 12b second lever
13, 13a, 13b second eccentric drive
14 control
15 dosing device
16 outlet opening
17 bearing, cardan bearing, ball joint
18 outlet line
20 second inlet line
21a source for pressurized gas
21b vacuum source

1. A mixer comprising a container having a tapered cross-section, and an inlet opening and an outlet opening opposite one another along a longitudinal axis of the container, wherein the container is only partially completely rotatable, and
a drive configured to drive the container to reciprocating movement along a trajectory curve perpendicular to or about the longitudinal axis,
wherein the inlet opening is arranged in a terminal region of the larger cross-section of the container and the outlet opening is arranged in a terminal region of smaller cross-section of the container.

2. The mixer according to claim 1, wherein the container is pivotably fixedly connected to the drive.

3. The mixer according to claim 1, wherein the container is mounted non-rotatably in a cardanic bearing.

4. The mixer according to claim 1, wherein the outlet opening is formed by the terminal region of smaller cross-section.

5. The mixer according to 1, comprising an inlet line tightly connected to the inlet opening and at least one dosing device connected to the inlet line, to the dosing device being configured to continuously dose at least two ingredients.

6. The mixer according to claim 1, wherein the container is cardanically mounted in a bearing and the drive is mounted at a spacing from the bearing.

7. The mixer according to claim 6, wherein the bearing is a cardan bearing or a ball joint.

8. The mixer according to one of the claim 1, wherein the drive comprises at least a first partial drive and a second partial spaced apart therefrom along the longitudinal axis, the first partial drive being configured to drive the container along a first trajectory curve and the second partial drive being configured to drive the container along a second trajectory curve which differs from the first trajectory curve.

9. The mixer according to claim 8, wherein the first trajectory curve has a longer path and/or a higher frequency than the second trajectory curve, the outlet opening being arranged closer to the first partial drive than to the second partial drive.

10. (canceled)

11. The mixer according to claim 5, wherein the container comprises an inner wall arranged inside and at a spacing from an outer container wall, wherein the inner wall comprise fluid-permeable openings, and the mixer comprising a second inlet line connected to an interstitial space between the outer container wall and the inner wall, wherein the interstitial space connected to a compressed gas source or to a vacuum source.

12. The mixer according to claim 1, wherein the drive and the container are configured to be driven along a trajectory curve which can be generated by superimposing the reciprocating movement along each of the at least two axes at different frequencies and/or different speeds along each of the axes.

13. The mixer according to claim 1, wherein the at least one trajectory curve comprises a sequence of trajectory segments which can be generated by superimposing the reciprocating movement along at least two axes with different frequencies and/or with phase offset and which each comprise exactly one complete reciprocating movement along the axis along which the reciprocating movement takes place with the lower frequency and each having at least one apex in which the direction changes by at least 90° within a maximum of 24.5% of the length of a trajectory segment.

14. The mixer according to claim 13, wherein the trajectory segments have at least one apex in which they change their direction by at least 120° within a maximum of 10% of the length of a trajectory segment.

15. The mixer according to claim 1, wherein the drive is configured to change frequencies and/or the phase offset during the reciprocating movement.

16. The mixer according to claim 15, wherein a difference in the frequencies is at least 0.01 Hz and 0.01% to 900% and/or the phase offset is 0.0028% to 50% of the length of a trajectory segment.

17. The mixer according to claim 1, wherein the trajectory curve comprises at least one trajectory segment which comprises a rectilinear section.

18. The mixer according to are driven by claim 1, wherein the drive comprises transmission in the form of a belt drive and/or a friction gear driven by exactly one motor.

19-21. (canceled)
